(19) United States
(12) Patent Application Publication
(10) Pub. No.: US 2006/0172584 A1
(43) Pub. Date: Aug. 3, 2006

(54) Cable retention device

(76) Inventor: Christian Hidalgo, Waltham, MA (US)

Correspondence Address: LAMBERT & ASSOCIATES, P.L.L.C., 92 STATE STREET, BOSTON, MA, 02109-2004, US

(21) Appl. No.: 11/049,419

(22) Filed: Feb. 2, 2005

(51) Int. Cl. H01R 13/62

(52) U.S. Cl. 439/369

(57) ABSTRACT

Provided is a cable retention device that is designed to retain audio cables within auxiliary audio components. The auxiliary component can be chosen from any number of accessories, but is preferably a standard guitar foot pedal. The cable retention device comprises a resilient elongate strip through which audio cables may be inserted. When the elongate strip is of a length that results in a substantially taut alignment with a portion of the guitar pedal perimeter, the resultant forces prevent accidental disengagement of the audio cables due to the forces that normally accompany musical performances.

### BACKGROUND OF THE INVENTION

1. Field of the Invention

This invention relates generally to the field of cord or cable retention, and more particularly to a cord retention device that may be used in applications that include audio cables and related accessories.

2. Description of the Related Art

Cord retention devices are numerous within the field. The problem is a fairly simple one; when mated, cords do not normally include sufficient retention forces to prevent disengagement during normal use. In the case of so-called electrical extension cords, engagement is accomplished by means of insertion of the prongs of the male plug into the receiving portions of the female plug. In these configurations the retention forces are a result of the frictional forces acting between the prongs of the male portion and the receiving portion of the female plug. These retention forces are normally sufficient to overcome slight disengagement forces, but are not capable of withstanding anything greater than the slightest tug in an axial direction opposite to the engagement direction. Therefore, the advent of the extension and other electrical cords was quickly followed by the introduction of various devices designed to prevent the disengagement of these electrical cables.

It almost goes without saying that the prevention of such disengagement is an important problem to combat. The application that the cords are used in may be such that disengagement is not an option, whether for economic or safety concerns. There also exists a host of situations where disengagement is a frustrating event that people wish to avoid. This alone was enough to spur the creation of a variety of solutions to this problem.

Perhaps the simplest solution, in the case of two mated electrical cords, is to tie an overhand knot in the cords prior to engaging the male and female ends. The result then, is that disengagement forces in the axial direction, relative to the cords, will tighten the knot rather than act to disengage the mating portions. The problem with this solution is primarily the wear and tear caused by the tightening of the cords and the angles that the knot creates.

Not surprisingly, there exists numerous prior art solutions designed to provide a better solution to preventing disengagement while retaining the integrity of the cords themselves. Some of these solutions are listed below to help provide a better understanding of current state of the art.

Kneebone, U.S. Pat. No. 2,461,427 discloses a device that utilizes frictional forces to prevent the disengagement of mated electrical cords. A slot connected to a round opening is used to slide over the cable portion of an electrical cord. The device is generally flat and also includes a hook portion at the end opposite the slot-hole portion to be made of flexible material with resilient properties.

Westberg, U.S. Pat. No. 2,720,633 discloses an electrical connector that clips to the cord portion of electrical cables. The body of the device is a spring member that is designed to resist disengagement forces that might act upon electrical cords during normal use. The particular shape and design of the clamping portion may be alterable with respect to varying cord types and applications.

Kopeski, Jr., U.S. Pat. No. 4,773,874 discloses a power cord clip that is preferably resilient in nature. Therefore, the electric cords are retainably mated by means of the resiliency of the clip, which will resist any deformations in a direction that would act to disengage the cords. A “slot-larger opening” combination is also employed.

Osten, U.S. Pat. No. 5,336,106 discloses a device that includes what can be described as a barbell shaped opening through which the cord of an electric cable may be passed and secured. One aspect of note is that the device is designed to yield should forces acting upon the cord reach a level that would potentially rupture the cord.

McCracken, U.S. Pat. No. 5,593,312 discloses a device that incorporates a single hole large enough for a plug to pass through, and includes a more narrow slot portion that will prevent the plug from being pulled. The slot is preferably sized to provide some pressure on the cord itself, thereby providing additional security in the form of frictional forces.

Voss, U.S. Pat. No. 5,628,646 discloses an electric cord plug retaining device designed to secure two plugs by means of slots adjoining larger openings. The narrow slots prevent the wider plug portions of the electric cords from sliding apart, and thereby disengaging.

Stodolka, et al., U.S. Pat. No. 5,732,445 discloses an electric cord retainer that includes slits that end in openings large enough to allow the cord to pass through. The male and female portions of opposing cords may then be secured by means of VELCRO or similar material.

Cook, U.S. Pat. No. 6,033,251 discloses an extension cord lock that may secure a cord to an outlet, or to a second extension cord. When secured to another cord the device utilizes circumferentially tabbed portion that is passed through an opening on a flat, central portion. The openings include a round portion large enough for the tabbed portion to pass through; and also include a more narrow rounded slot that is smaller than the outer circumference of the tabs, thereby locking the device around the extension cord.

Although all of these prior art solutions may serve well for their intended purposes, they all fail to provide relief for a number of applications contemplated by the present invention.

Therefore, what is needed is cable retention device that may be utilized in applications outside the electrical cable sphere.

It is also required that a the cable retention device be quick and easy to use, as well as inexpensive to manufacture.

What is also required is a cable retention device that is appropriately sized to fit in a substantially taut fashion over the top portion of an auxiliary component perimeter.

What is further required is a cable retention device that is capable of retaining audio cables and the cables' accompanying jack portions, which are substantially smaller in circumference than standard electrical cord plugs.

### BRIEF SUMMARY OF THE INVENTION

Accordingly, it is an object of the present invention to provide a cable retention device that may be utilized in applications outside the electrical cable sphere.

It is a further object of the present invention to provide an appropriately sized retention device with respect to an auxiliary component perimeter.

It is also an object of the present invention to provide a cable retention device that is specifically adapted to retain audio cables and their correspondingly smaller jack portions.

### BRIEF DESCRIPTION OF THE SEVERAL VIEWS OF THE DRAWINGS

These and other features, aspects and advantages of the present invention will become better understood with reference to the following description, appended claims, and accompanying drawings where:

FIG. 1 is a perspective view of the cable retention device of the present invention.

FIG. 2 is an exploded view of the cable retention device of the present invention along with its accompanying components.

FIG. 3 is a top view of the cable retention device of the present invention along with its accompanying components in an assembled position.

FIG. 4 is a side view of the cable retention device of the present invention along with its accompanying components in an assembled position.

### DETAILED DESCRIPTION OF THE INVENTION

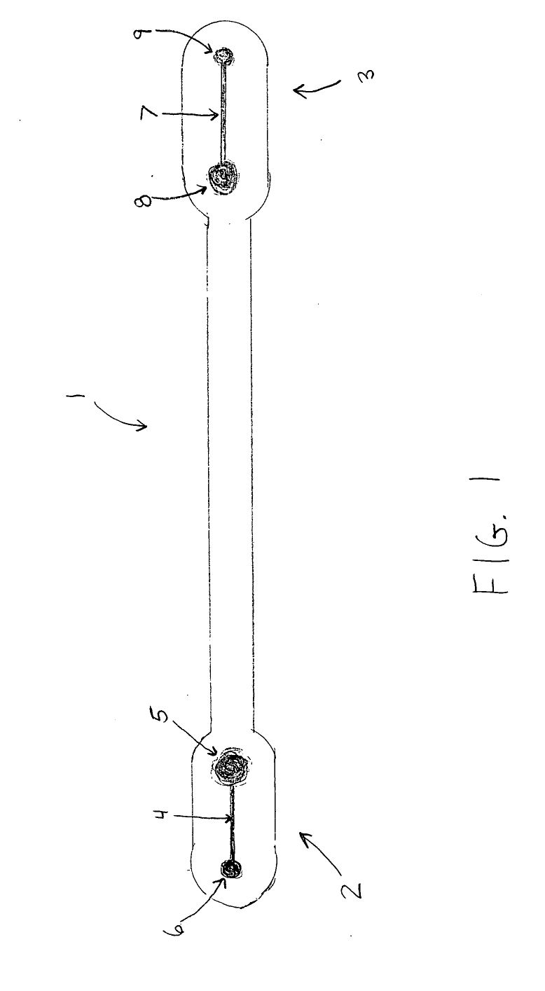

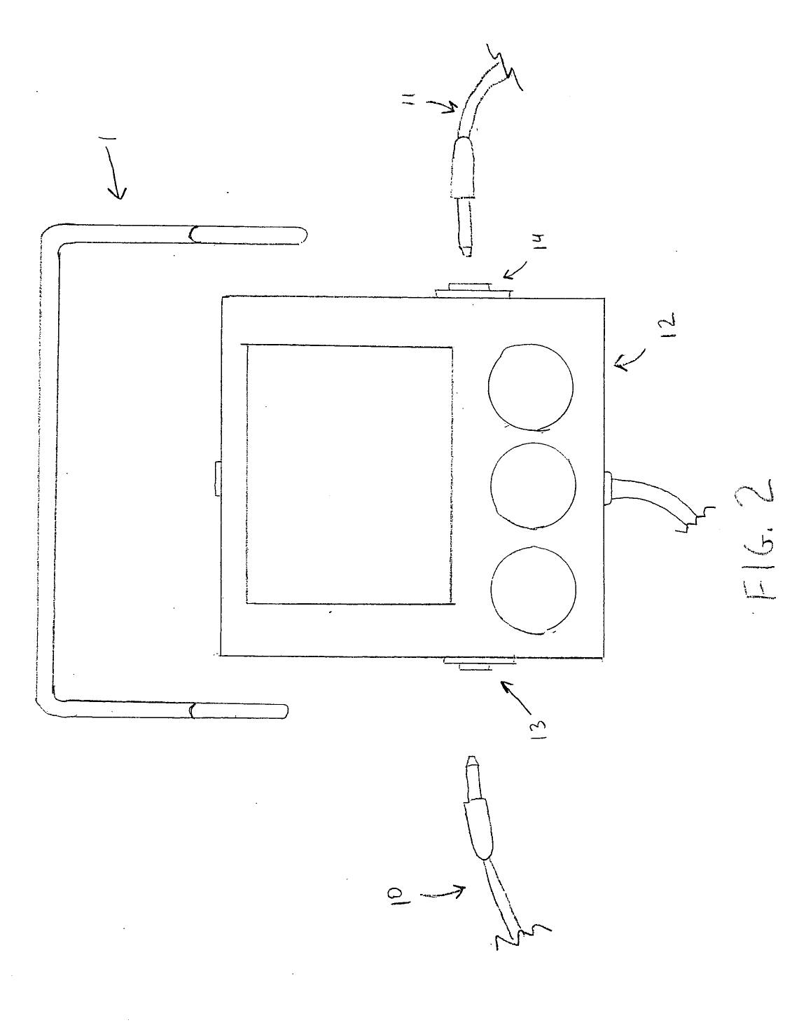

As can be seen from FIG. 1, the cable retention device 1 is shown. The cable retention device 1 comprises an elongate strip including a first insertion area 2 and a second insertion area 3. The insertion areas, 2 and 3, could include varying components of the displayed details. Namely, the cable retention device 1 could include only substantially linear slits 4 and 7 alone. In that embodiment, it would be desirable for slits 4 and 7 to be substantially flexible enough to allow insertion of the desired cables 10 and 11 (See FIG. 2). Alternatively, insertion areas 2 and 3 could include primary insertion points 8 and 5. The size of primary insertion points 8 and 5 is preferably slightly larger than the outer diameter of a standard audio cable jack. This size allows for easy and quick insertion of the audio cables into the cable retention device 1. The insertion areas 2 and 3 may also include the receiving points 6 and 9 as shown. The receiving points 6 and 9 are preferably located at the end of the linear slits 4 and 7, opposite to primary insertion points 8 and 5. This configuration would allow for insertion of the audio cables, and then receipt of the cables within the receiving points 6 and 9 upon final assembly. A point to note is that any combination linear slits 4 and 7, primary insertion points 5 and 8, and receiving points 6 and 9, jointly or alone, may be utilized.

FIG. 2 illustrates the cable retention device 1 of the present invention prior to final assembly. Also, the perimeter of the auxiliary component 12 that is of importance relative to the length of the cable retention device 1 can be seen as the perimeter distance from input 13 to output 14 of the auxiliary component 12. Preferably, the cable retention device 1 is aligned with the top portion of the perimeter of auxiliary component 12, but this is not an essential requirement. Rather, it would be simply more logical for a user to orient the cable retention device 1 with the top of auxiliary component 12.

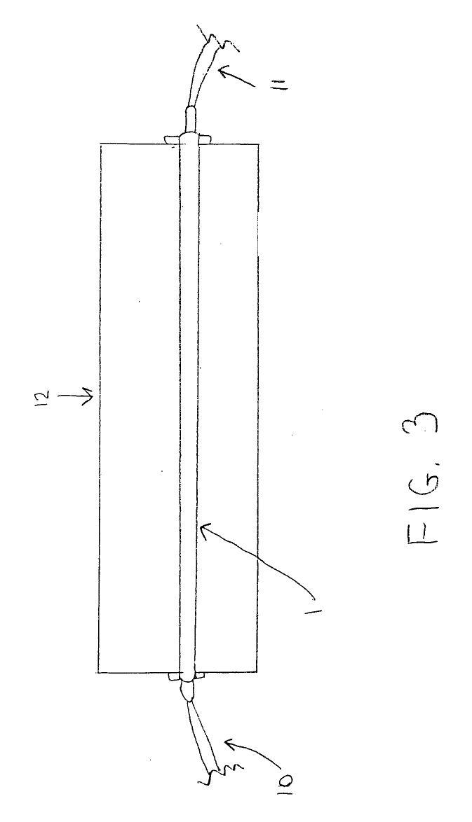

FIG. 3 displays a top view of the cable retention device 1 in an assembled configuration.

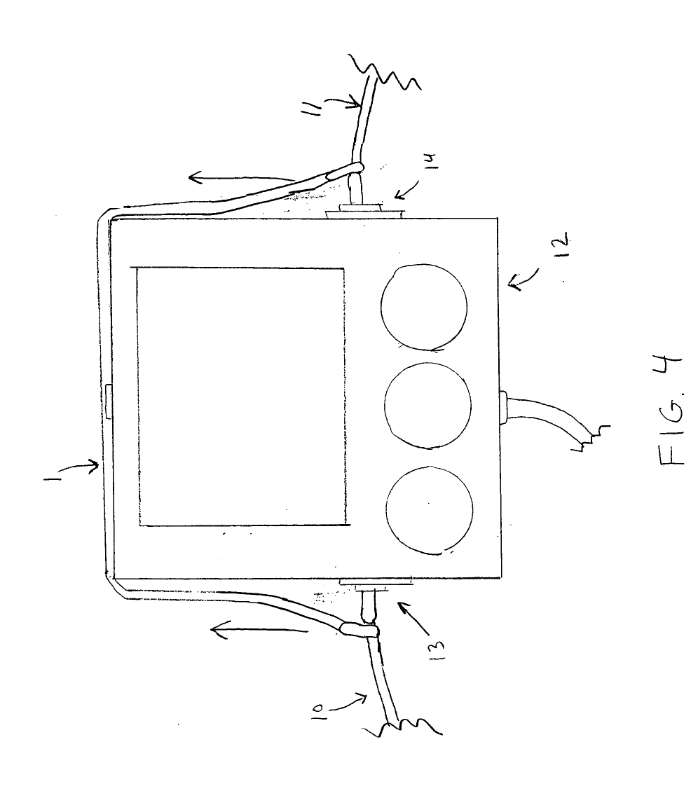

FIG. 4 shows a side view of the cable retention device 1 in an assembled manner. The arrows indicate the direction of the force imparted on the audio cables 10 and 11 by the cable retention device 1. From this configuration it can be seen that the preferable material for the cable retention device 1 is a material that is resilient. A resilient material would allow for easy assembly, and would be the best way to provide the restrictive forces necessary to retain the cables within the auxiliary component 12.

With the foregoing description in mind, it can be seen that the present invention provides a novel and useful way to retain audio cables within an auxiliary component that has not been heretofore discovered. Preferably, the auxiliary component is a standard guitar foot pedal, but it should be clear to those skilled in the art that slight variations, within the scope of the present invention, could be made for other applications. For example, the frictional forces created by the cable retention device of the present invention could be used for retaining a pair of cables without the inclusion of an auxiliary component. However, the preferred embodiment does include an auxiliary component as mentioned above.

The cable retention device will be of particular importance to musicians and performers considering a typical musical performance. For example, a so-called electric guitar often includes a first audio cable that is plugged into a foot pedal, and also includes a second audio cable that runs from the foot pedal output to a desired output device, such as an amplifier or speaker. It is often the case that said musician moves around the performance area, and necessarily imparts forces onto the audio cables in such a manner that may result in their disengagement from the foot pedal, output device, or both. Therefore, the frictional forces imparted by the cable retention device of the present invention is sufficient to prevent the accidental disengagement of the cables during normal use.

The preferred configuration details of the insertion areas 2 and 3 are also of importance to the best mode of using the present invention. The diameters of receiving points 6 and 9 correspond to the diameters of the audio cables 10 and 11. The receiving points 6 and 9 are also preferable located at the outermost portion of the insertion areas 2 and 3 because when assembled, the resiliency of the cable retention device 1 will result in the seating of the cables within the receiving points 6 and 9.

Although the present invention has been described with reference to particular embodiments, it will be apparent to those skilled in the art that variations and modifications can be substituted therefore without departing from the principles and spirit of the invention.

1. A cable retention system comprising:
an elongate strip, wherein said elongate strip comprises a first end and a second end and wherein said elongate strip includes a length dimension;
an auxiliary component, wherein said length dimension corresponds to said auxiliary component;
a first insertion area located at the first end of said elongate strip;
a second insertion area located at the second end of said elongate strip.

2. (canceled)

3. (canceled)

4. The cable retention system of claim 1, wherein said first insertion area comprises portions defining a substantially linear first slit.

5. The cable retention system of claim 4, wherein said second insertion area comprises portions defining a substantially linear second slit.

6. The cable retention system of claim 5, wherein said first insertion area further comprises portions defining a first primary insertion point.

7. The cable retention system of claim 6, wherein said second insertion area further comprises portions defining a second primary insertion point.

8. The cable retention system of claim 7, wherein said first insertion area further comprises portions defining a first receiving point.

9. The cable retention system of claim 8, wherein said second insertion area further comprises portions defining a second receiving point.

10. The cable retention system of claim 9, wherein said first primary insertion point comprises a circumference that is greater than a first receiving point circumference.

11. The cable retention system of claim 10, wherein said second primary insertion point comprises a circumference that is greater than a second receiving point circumference.

12. The cable retention system of claim 11, wherein said auxiliary component comprises a standard guitar foot pedal.

13. The cable retention system of claim 12, where said elongate strip further comprises a resilient material.

14. The cable retention system of claim 12, wherein said elongate strip further comprises a non-resilient material.

15. A cable retention system comprising:
an elongate strip, wherein said elongate strip comprises a resilient material, and wherein said elongate strip includes a first insertion area and a second insertion area, and wherein said elongate strip includes a length dimension, and wherein said first insertion area comprises portions defining a substantially linear first slit, a first primary insertion point, and a first receiving point, and wherein said second insertion area comprises portions defining a substantially linear second slit, a second primary insertion point, and a second receiving point;
an auxiliary component, wherein said auxiliary component comprises a standard guitar foot pedal, wherein said auxiliary component corresponds to said length dimension.

16. (canceled)

17. (canceled)

18. (canceled)

19. A method for retaining audio cables upon an auxiliary component, said method comprising the steps of:
inserting a first audio cable through a first primary insertion point of a first insertion area of a resilient elongate strip;
engaging a first jack of said first audio cable into an auxiliary component input;
inserting a second audio cable through a second primary insertion point of a second insertion area of said resilient elongate strip;
aligning said resilient elongate strip around a portion of said auxiliary component;
engaging a second jack of said second audio cable into an auxiliary component output;
allowing a first cable portion of said first audio cable to be received in a first receiving point of said first insertion area; and
allowing a second cable portion of said second audio cable to be received in a second receiving point of said second insertion area.

20. The method of claim 19, wherein said auxiliary component comprises a standard guitar foot pedal.
